(19) United States
(12) Patent Application Publication
(10) Pub. No.: US 2018/0332073 A1
(43) Pub. Date: Nov. 15, 2018

(54) Moving Target Defense for Distributed Systems

(71) Applicant: Government of the United States, as represented by the Secretary of the Air Force, Rome, NY (US)

(72) Inventor: Noor Ahmed, Syracuse, NY (US)

(21) Appl. No.: 15/812,093

(22) Filed: Nov. 14, 2017

Related U.S. Application Data
(60) Provisional application No. 62/503,971, filed on May 10, 2017.

(51) Int. Cl. H04L 29/06; G06F 9/48; G06F 9/455

(52) U.S. Cl. CPC H04L 63/1441; G06F 9/4856; G06F 2009/45591; G06F 9/4881; G06F 9/45558

(57) ABSTRACT

An apparatus and method defends against computer attacks by destroying virtual machines on a schedule of destruction in which virtual machines are destroyed in either a random sequence or a round-robin sequence with wait times between the destruction of the virtual machines. Also, each virtual machine is assigned a lifetime and is destroyed at the end of its lifetime, if not earlier destroyed. Destroyed virtual machines are reincarnated by providing a substitute virtual machine and, if needed, transferring the state to the substitute virtual machine. User applications are migrated from the destroyed machine to the replacement machine. All virtual machines are monitored for an attack at a hypervisor level of cloud software using Virtual Machine Introspection, and if an attack is detected, the attacked virtual machine is destroyed and reincarnated ahead of schedule to create a new replacement machine on a different hardware platform using a different operating system.

### CROSS REFERENCE TO RELATED APPLICATIONS PRIORITY CLAIM UNDER 35 U.S.C. § 119(E)

This application cross references, and claims priority under all applicable statutes to, U.S. provisional application No. 62/503,971, filed May 10, 2017. The provisional application (62/503,971) is incorporated by reference as if fully set forth herein.

### STATEMENT OF GOVERNMENT INTEREST

The invention described herein may be manufactured and used by or for the Government for governmental purposes without the payment of any royalty thereon.

### FIELD OF THE INVENTION

This invention relates to the field of computers and computer defense methods. More particularly, this invention relates to a computer apparatus implementing a self-destruction and reincarnation target defense to defend the computer against attacks.

### BACKGROUND OF THE INVENTION

Attacks against computer systems have become increasingly sophisticated and increasingly problematic. This problem has been particularly acute in distributed computer networks, such as cloud-based computer networks. The traditional defensive security strategy for distributed systems is to safeguard against malicious activities and prevent attackers from gaining control of the system. The traditional strategy employs well-established defensive techniques such as perimeter-based firewalls, redundancy and replications, and encryption. A more recent form of defense has been called a moving target defense because computer assets, such as user applications, may be monitored for an attack and moved from place to place if an attack is detected. However, given sufficient time and resources, all of these methods can be defeated by advanced adversaries.

### SUMMARY

The present invention addresses the problem of malicious computer attacks by employing a sophisticated combination of techniques to maximize the cost of attacking a distributed system and thereby minimizing the probability of a successful attack. In particular, a proactive strategy is employed in combination with reactive strategies in order to maximize the cost of an attack. One proactive strategy provides for proactive self-destruction and reincarnation of computer assets, particularly virtual machines. This strategy in combination with sophisticated attack monitoring schemes reduces or eliminates the need to keep one step ahead of sophisticated attacks.

For example, in one embodiment a computer apparatus includes at least one computer and at least one operating system. Cloud software is also running on the computer and provides a plurality of virtual machines, and user applications are interfaced with at least some of the virtual machines. Defense software is implemented on the cloud software and provides the capability of destroying and reincarnating virtual machines regardless of whether they are being attacked. The defense software is operable to use the cloud software to create virtual machines and to proactively destroy virtual machines on a schedule of destruction. Thus, virtual machines are proactively destroyed even though no attack has been detected. Thus, if a virtual machine is under attack, but the attack has not yet been detected, the proactive destruction of the virtual machine will defeat the attack. Also, from the point of view of the attacker, the destruction of virtual machines for no apparent reason makes an attack more difficult because the virtual machine will probably not be available for an attack for a sufficient amount of time to successfully perform the attack. In preferred embodiments, the lifespans of all virtual machines will vary randomly such that it is difficult to predict the lifespan of any virtual machine, and all virtual machines will have a relatively short lifespan, meaning a lifespan that is sufficiently short to make an attack unlikely to be successful.

When a particular virtual machine is destroyed, it is also reincarnated. Reincarnation is accomplished by providing a replacement virtual machine and migrating user applications from a particular virtual machine to be destroyed to the replacement virtual machine. The replacement virtual machine may have different characteristics as compared to the destroyed machine. For example, the replacement virtual machine may be created on a different hardware platform and the operating system of the new hardware platform may also be different as compared to the operating system of the hardware platform of the prior destroyed virtual machine. Thus, if an attack had started on the prior destroyed machine, that attack is likely to not be effective against the replacement virtual machine because of the aforementioned differences.

To perform the migration, it is often necessary to transfer the state of the destroyed virtual machine to the replacement virtual machine. Thus, before a particular virtual machine is destroyed, the state of the virtual machine is obtained or copied. This state is then transferred to the replacement virtual machine, and the user application that was operating on the destroyed virtual machine is connected to (interfaced with) the replacement virtual machine, and the user application continues its operation as if it were still operating on the destroyed virtual machine. In some embodiments, the technique takes advantage of recovery programming in which user applications are programmed to recover in the event that they lose connection with a virtual machine. The user applications repeatedly try to reconnect to their virtual machines, and the process of destruction and reincarnation is performed quickly such that the user application will reconnect to the reincarnated virtual machine as if it were the original destroyed machine.

In one embodiment at least two destruction techniques are superimposed such that either destruction technique may cause the destruction of the virtual machine. A first destruction procedure is run when at least one group of virtual machines are selected for destruction and the virtual machines in the group are destroyed in a random sequence with the wait times between the destruction of the virtual machines. This destruction procedure creates an indirect limit on the life of a virtual machine. The overall number of virtual machines in the group and the length of time of the wait time will create a limit on the actual life of the machine, but it will be highly unpredictable. A second destruction procedure is superimposed on the first destruction procedure. In the second destruction procedure, each virtual machine in the group is assigned a lifetime and each virtual machine in the group is destroyed at the end of the lifetime that is assigned to the virtual machine. It is possible that the first destruction procedure will destroy a particular virtual machine before the end of its lifetime and in which case the second destruction procedure has no effect on the lifetime of the particular virtual machine in question. However, if the first destruction procedure has allowed a particular virtual machine to exist for the entire lifespan that was assigned to it, the second destruction procedure will destroy the particular virtual machine.

Both the first and the second destruction procedures may be randomized meaning that the parameters imposed by each may be pseudo-randomly selected. For example, the order in which the virtual machines are destroyed under the first destruction procedure can be randomized by simply selecting machines for destruction in a pseudorandom manner. Likewise, the wait times utilized by the first destruction procedure may be randomized between upper and lower limits. The second destruction procedure is randomized by employing a pseudorandom procedure to determine the lifetime of each virtual machine such that the lifetime will randomly vary between an upper and a lower limit.

Alternatively, one or both of the first and second procedures can operate in a nonrandom fashion. For example, the first destruction procedure may select virtual machines were destruction in a nonrandom round-robin order based on the age of the virtual machines in the group such that the oldest machines in the group are selected for destruction at the earliest times. Likewise, the second destruction procedure could impose the same lifetime on all virtual machines. This lack of randomization will increase the predictability of the life of each machine, but an attack on each machine will still be difficult because of its short lifespan.

The defense software may also be configured to monitor the virtual machines on the network for an attack, and if an attack is detected, the destruction of the virtual machine will occur immediately in advance of its schedule destruction. Thus, the presence of an attack will change the lifespan of all virtual machines under the first destruction procedure because it will change the order in which the machines are destroyed, but the lifespan imposed by the second destruction procedure will be unaffected. In one embodiment the virtual machines are monitored for an attack using the cloud software and a Virtual Machine Introspection technique. In particular, such monitoring may occur at the hypervisor level of the cloud software which means that the monitoring of the virtual machines will be done externally of the machines themselves. This monitoring will be able to detect side channel attacks and will also detect an attack that may difficult to detect from within the virtual machine itself.

The reincarnation technique may provide new replacement virtual machines using a number of different techniques. The fastest, but least secure technique, would be to create a number of spare replacement virtual machines complete with interfaces that are ready to be connected to a user application. A more secure technique would be to create spare replacement virtual machines but maintain them without interfaces. When they are needed, these machines must be provided with an interface and then assigned to connect with a user application. The most secure technique is to create replacement virtual machines just in time. When a virtual machine is scheduled to be destroyed under the schedule of destruction or because a virtual machine is being attacked, creation of a replacement machine begins at a time selected to allow the new virtual machine to be created in time (preferably just in time) to function as the reincarnated virtual machine.

In the case of some user applications it is not necessary to transfer the state of a user application from a destroyed virtual machine to the reincarnated virtual machine. For example, some user applications create multiple duplicate copies of the user application running on multiple virtual machines. The duplicate copies of the user application each have the state information and the duplicate copies of the application are periodically synchronize thereby synchronizing their state information. The defense software detects the presence of this type of user application, and in such case, the virtual machines operating the user application will be subjected to a destruction schedule as described above. The reincarnation process creates or provides a new replacement virtual machine without transferring the state of the destroyed virtual machine. Then, the reincarnated virtual machine will be connected to the user application and will be allowed to synchronize with the duplicate copies of the user application thereby acquiring the state from the duplicate running copies of the application.

The computer apparatus and the methods performed by the computer apparatus as describe above are considered part of the invention as defined by the claims.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a simplified flow chart illustrating one embodiment of the method for defending a computer network;

FIG. 2 is a schematic diagram and graph representing the physical structure of a computer network on the vertical axis and illustrating the operation of the defense method over time on the horizontal axis;

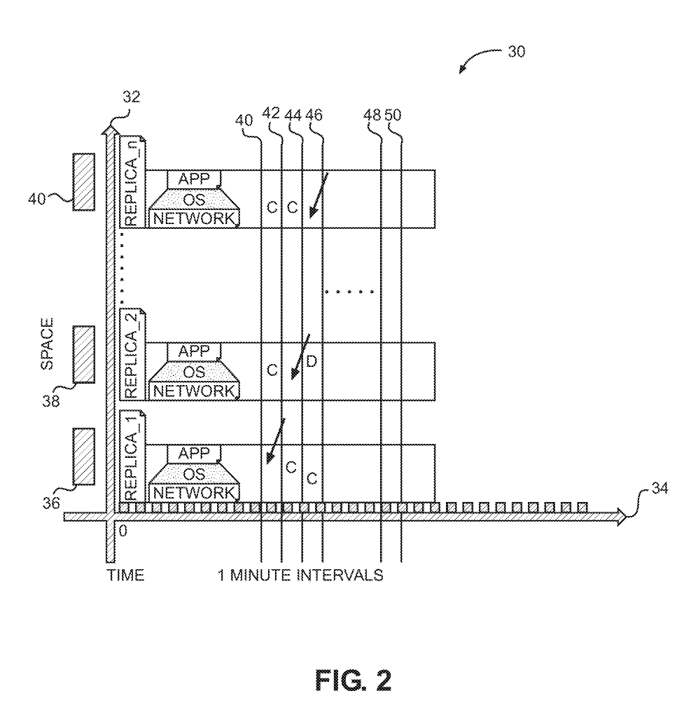

FIG. 3 is a schematic diagram of hardware and software of a cloud based network illustrating the operation and abstraction levels of the defense software;

FIG. 4 is a schematic diagram of hardware and software of a cloud based network illustrating the operation and abstraction levels of the defense software and showing the interconnection between the cloud framework, the hardware and the defense software; and

FIG. 5 is a concentric circle schematic diagram of hardware and software of a cloud based network, including the defense software, illustrating the layered nature of the software, and illustrating the interfaces between the virtual machines and the host hardware and between the virtual machines and the clients (user applications).

### DETAILED DESCRIPTION

Overview

An attack-resilient framework employs a defensive security strategy to narrow the window of their vulnerability from hours/days to minutes/seconds. This is achieved by controlling the system runtime execution in time and space through diversification and randomization as a means of shifting the perception of the attackers' gain-loss balance. The goal of this defensive strategy, commonly referred to as Moving Target Defense (MTD), is to increase the cost of an attack on a system and to lower the likelihood of success and the perceived benefit of compromising it. This goal is achieved by controlling a node's exposure window of an attack through 1) partitioning its runtime execution in time intervals, 2) allowing nodes to run only with a predefined lifespan (as low as a minute) on heterogeneous platforms (i.e., different OSs), while 3) pro-actively monitoring their runtime below the OS. (The term “node” as used herein typically refers to a virtual machine unless the context of the sentence indicates a broader meaning of “node”.)

The defense disclosed herein is dubbed the Mayflies Defense or Mayflies because it was inspired by the insect known by that name, namely, Ephemeroptera. Depending on the type of Mayfly species, some adult females live less than five minutes during which they find a mate, copulate, and lay their eggs. The Mayflies Defense uses a similar strategy to defend nodes against attacks by creating nodes (virtual machines) and destroying the nodes rapidly, limiting each node to a short lifespan. The short lifespan is chosen to be long enough to support efficient operation of a user application on a virtual machine, but short enough to effectively protect against attack. The definition of a short lifespan depends on many factors including the type of computers in a network, the type of Cloud software in use, the operating systems that are used, and the type of applications that are running on the virtual machines. In most cloud software environments, a short lifespan would be less than an hour and typically a short lifespan would be on the order of one minute.

The Mayflies defense is intended primarily for use on distributed systems, such as cloud based systems, but the defense could be used on other computer systems as well. There are three classes of distributed systems; Synchronous, Asynchronous, and Probabilistic. The former two are those common in distributed systems deployed in cloud environment. For Synchronous systems, as the name implies, the interac-tion/communication protocols between the nodes (i.e., SOAP-based clients/servers model) are synchronized, where as the Asynchronous class communication protocols (i.e., request/response, push/pull data models) are not synchronized (i.e., the request is independent of the response in time/space).

Besides the standard-based lightweight services (i.e., web-services) that are widely adopted in the commercial sector and on social sites, the event-based Publish and Subscribe (pub/sub) and the Quorum-based Byzantine Fault Tolerant (BFT) systems are the two widely deployed protocols in the cloud environments and studied in the literature. The key design difference is that in pub/sub, typically, a broker(s) mediates the exchange of topic/content-based messages between the producers (publishers) and consumers (subscribers) of the information (i.e., stock trading apps, cloud internals), thus, it is an Asynchronous system. In contrast to the BFT systems where a number of replica need to process client requests in an ordered and Synchronous fashion, these systems are designed and modeled with different replication models (i.e., chain, quorum and others) and failure models (i.e., Byzantine Faults). The disclosed Mayflies defense framework introduces a unified and generic system agility enabling it to operate on most could platforms. There are a number of cloud frameworks that simplify the management of the cloud platforms. These include; Eucalyptus, OpenNapula, OpenStack, Cloudstack and Nimbus. The disclosed Mayflies defense framework is built on top of an OpenStack framework, but the other cloud platforms could be used as well.

The attack model of the Mayflies defense considers an adversary taking control of a node/VM by bypassing the traditional defensive mechanisms, a valid assumption in the face of novel attacks. The adversary gains systems' high privileges and is able to alter all aspects of the applications. Traditionally, the adversaries' advantage, in this case, is the unbounded time and space across the replicas to compromise and disrupt the reliability of the entire system. The commonly studied disruptive behavior for reliable distributed systems is known as a Byzantine Failure Model, in which several compromised nodes deviate from the specified system protocol.

The Mayflies defense is particularly effective and needed in a replicated systems model where the adversary can exploit many replicas in order to collude. Specifically, the defense addresses adversaries that exploit systems with rootkits to compromise the OS. Because the Mayflies defense allows the replicas to exist for a short time in which that lifespan can be hard-wired in the application, the defense protects the replica right from start of the replica.

The Mayflies defense further assumes the attacker takes a minimum time t to compromise a node n, and having seen or attempted to compromise n with a given tactic devised for a given exploit will not reduce the time to compromise a new node n′. This is because the new node n′ will require a new tactic and new exploit to compromise it given the fact that it starts with new characteristics such as different OS, on different hardware and hypervisor. Furthermore, the adversary can employ arbitrary attacks on the nodes in the replica group only.

Simplified Flow Chart

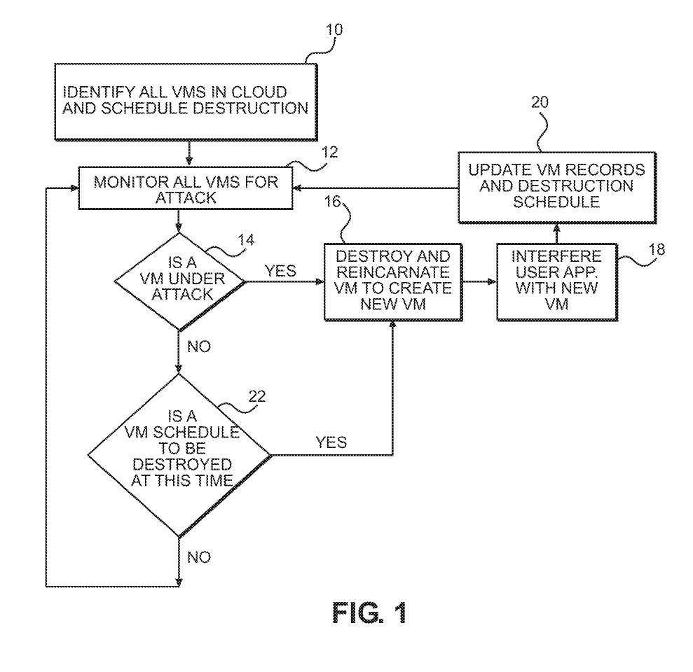

Referring now to FIG. 1 a flowchart is shown illustrating one simplified logic flow of the Mayflies defense. Beginning at block 10, the Mayflies program identifies all VMs on the network and schedules their destruction. Many of the VMs may be interfaced with user apps, and those VMs are scheduled for destruction. During this step additional VMs may be created for later use, and these additional VMs are scheduled for destruction also. Each VM will have a scheduled lifespan, which may be pseudo-randomly determined, but each lifespan will be set between a predetermined maximum and minimum lifespan. The lifespans may also be set in a non-random fashion where all VMs have different lifespans, or they may all have the same or approximately the same lifespan. The Mayflies defense may be implemented on many computer systems but it is primarily designed for implementation on a Cloud network.

As shown by block 12, the software begins to monitor all VMs for attack and if a VM is discovered to be under attack, the attacked VM is destroyed in advance of its scheduled destruction time and the destroyed VM is reincarnated to create a new VM to take the place of the destroyed VM as indicated by blocks 14 and 16. In some cases, the state of the VM is saved before the VM is destroyed and the state is transferred to the reincarnated new VM, but in other cases there is no need to transfer the state.

If a VM was supporting the operation of a user application at the time of its destruction, the connection between the two is obviously lost when the VM is destroyed, but as indicated at block 14, the reincarnated new VM is connected to the user application and immediately begins to run the user application as if it were the old destroyed VM. For example, a reincarnated new VM may be given the same interface as the destroyed VM and the user application reconnects quickly and automatically because the user application is programmed to attempt to reconnect to the VM if it loses communication with the VM. If a VM was not supporting a user application at the time of its destruction, it is obviously not reconnected to a former user application, but it is available for any user application in the future.

The reincarnation process is not blind, meaning it takes into consideration the VM that was attacked. The reincarnated VM is made to be different from the attacked VM so that it will not be susceptible the same attack. A reincarnated VM may be created on different hardware running a different operating system as compared to the attacked VM.

When a VM is destroyed and reincarnation occurs, Mayflies updates the records of the existing VMs and the destruction schedule. The destroyed VM is removed from the records and the reincarnated VM is added. In addition, Mayflies may create additional VMs for future use and these additional VMs are added to the records including the destruction schedule.

Returning to block 14, if no VM is under attack, the program moves to block 22, and checks to determine whether any VM is scheduled for destruction and if so, the VM is destroyed and reincarnated as indicated at block 16. As before, if the VM was supporting a user application, the reincarnated VM is created in such a way as to support the user application, and if needed, the state of the destroyed VM is transferred to the reincarnated new VM.

If no VM is scheduled for destruction, the logic of the program returns to block 12 and the process of monitoring for attack and destroying VMs on a schedule continues. The normal operation of the Mayflies defense will be the continuous process of destroying VMs on a schedule. If the defense is implemented properly, the lifespan of each VM will be sufficiently short so that attacks will not have time to begin, or if they begin, the VM will be destroyed before the attack is detected. If an excessive number of attacks are detected, the lifespans of the VMs may be reduced so that the proactive scheduled destruction of VMs is sufficient to defeat most, if not all attacks.

In this simplified flow chart, block 14 is positioned in advance of block 22 to emphasize that the attacked VMs are destroyed in advance of their scheduled destruction, but the processes of monitoring for attack and destroying VMs on a schedule may be occurring simultaneously and an attacked VM may be destroyed at the same times that a VM is destroyed because of a scheduled destruction. If one of the destructions must be given priority, the attacked VM will be destroyed first and the scheduled destruction of a VM may be delayed.

Computer Network Environment

FIG. 1 is a diagrammatic illustration of the Mayflies defense operating in a computer network environment 30 in which the vertical axis 32 represents space and the horizontal axis 34 represents time. Computers 36, 38 and 40 represent a plurality of computers distributed in space and the lines 40-50 represent a number of time intervals, one-minute intervals for example. In each time-interval, the Mayflies defense terminates a node and activates a new one while the defense is observing the runtime of the other nodes and marking the other nodes based on proactive monitoring. One technique of proactive monitoring used by the Mayflies defense is known as Virtual Machine Introspection. Based on VMI, the defense marks the node as either Clean (C) for a node whose internal runtime is intact or Dirty (D) for a compromised node. To illustrate this concept, in FIG. 1, in the third termination round (between lines 44 and 46), the defense software detects replical to be clean and replica-2 as dirty as shown by time-interval entry D. In the next time-interval, it terminates replica-2 prior to any other replica scheduled for termination. In general, the nodes whose entry show D takes priority over the scheduled node in each time-interval, thus, preventing the nodes to blindly move across platforms.

This defensive tactic makes the attacker's job difficult to compromise a node, for instance, by the time the reconnaissance of the node (i.e., OS fingerprinting), exploiting vulnerabilities (understanding app/memory layout), and crafting the attack (i.e., code injection attack) process completes, there is a high chance of the node changing in space during the attack. In the case where the attack was crafted earlier and succeeds in a short time, then, the node is under the control of the attacker for a short time since it gets terminated eventually in the subsequent time-intervals. If detected, then the defense software terminates that node instead of the scheduled one, and learns to avoid that specific node configuration for the next time interval.

The Mayflies defense framework is built on randomization and diversification techniques, referred to as Reincarnation. To prevent moving blindly in space, the defense framework is integrated with a proactive monitoring scheme below the OS using Virtual Machine Introspection. This allows the defense to effectively move nodes across platforms for defensive measures and avoid configuration combinations (i.e., OS, hypervisor) and platforms (i.e., hardware) that are susceptible to attacks.

With these two capabilities, coupled with the formal model of the Mayflies defense framework, the Mayflies defense can observe the high-level system behavior in each time-interval as to whether nodes are in desired (i.e., initially deployed) states, or undesired states (i.e., under attack or compromised).

As used herein, Reincarnation refers to a technique used by the Mayflies defense for enhancing the resiliency of a system by terminating a running node and starting a fresh new node with different characteristics (i.e., hypervisor, OS) in its place. This new node will continue to perform the computing task as its predecessor without disrupting the computations (i.e., application runtime). All the nodes in the proposed Mayflies defense framework have a predefined short lifespan, as low as a minute, and an observation status that dictates whether the node reaches its lifespan or is reincarnated prematurely due to attacks. For instance, some replication models (i.e., quorum-based) have ⅔rd of the nodes running in sync at all times. As a result, some nodes are exposed to attacks longer than others, and thus, prioritizing node reincarnation is critical.

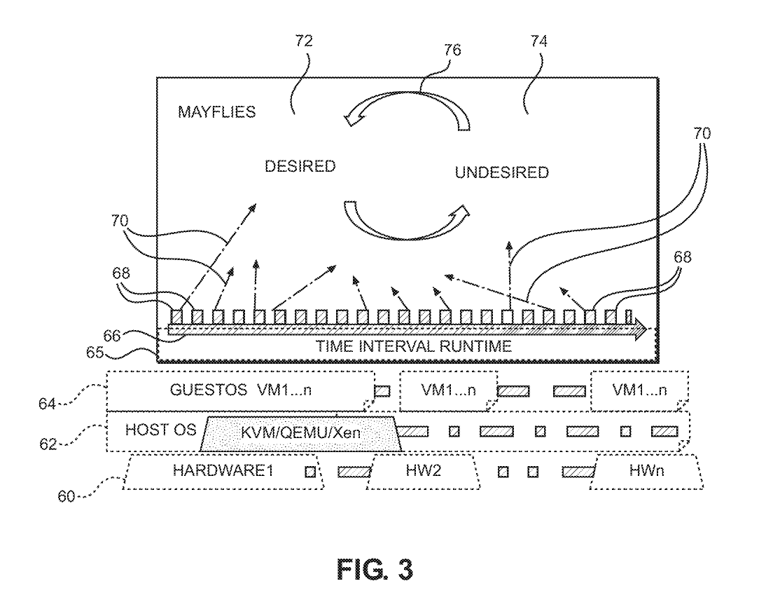

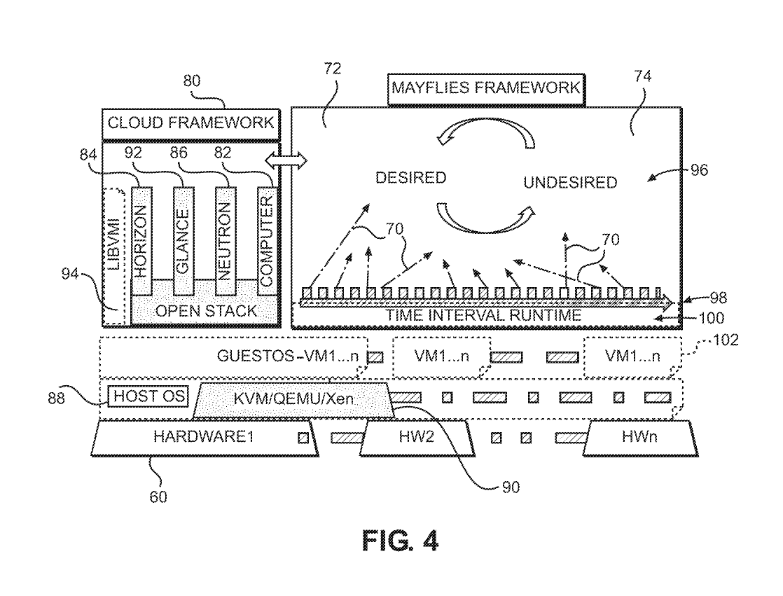

The Mayflies defense framework as illustrated in FIG. 3 adopts a cross-vertical design that operates on three different logical layers of the OpenStack cloud framework; the nova compute at the application layer (GuestOS layer 64), the VM/at the hypervisor layer (HostOS layer 62), and the neutron 86 at the (FIG. 4) networking layer (SDN). These three logical layers of the cloud abstracts the applications deployed in these platforms (Hardware 60) regardless of their architectural styles or system models into unified virtual computing environments (VMs). The Mayflies defense further extends the abstraction of the applications' runtime in these VMs without changes to the applications deployed in them.

In a cloud platform built with OpenStack, the nova compute abstracts the virtual machines from the applications in order to isolate (i.e., multi-tenancy) each other while sharing the same physical hardware in pursuit of cost efficiency and ease of integration and deployment. Technically, this isolation is achieved by provisioning and de-provisioning VM instances on available platforms (hardware), and the programmable Software Defined Networking (SDN). The process for sharing the resources is mediated by the hypervisor and is achieved by stopping a VM from execution and resuming another one without any consideration of the actual running application architecture or system model, referred to as VMEntry and VMExit.

As illustrated in FIG. 3, the Mayflies defense framework introduces two abstraction layers on top of the traditional application runtime that is already abstracted within a VM by the cloud framework as eluded above. The first abstraction is the Time-interval Runtime Execution (TIRE 65). TIRE 65 partitions the runtime into time-intervals, depicted as the dots 68 on the arrow time line 66, in order to evaluate the system state (i.e., desired and undesired) within these time intervals.

The defense framework pro-actively terminates a VM and starts a new one on heterogeneous platforms (hypervisors, OS's) at runtime by extending the asynchronous model of the VM provisioning and de provisioning of nova compute API implementation, and dynamically swapping the network interfaces with the neutron API implementation of the SDN.

The second abstraction is the two high-level system states; desired 72 and undesired states 74, to formally reason about the system behavior. The driving engine of these states are; a) the pro-active monitoring scheme used to detect system runtime integrity violations below the OS using virtual introspection, and b) the pro-active node reincarnations in time-intervals. Based on the observation depicted by the dash-dot arrows 70 on the TIRE 65, the Mayflies defense framework determines the system state in each time-interval as to whether the system is still in its desired state (i.e., initially deployed state) or is in undesired state (i.e., compromised) and, if so, reactively anticipates states changes in the subsequent time-intervals. These abstraction layers allow randomization and diversifications on all types of distributed systems in any cloud platform (i.e., OpenNapula, Eucalyptus).

The Mayflies defense framework is built on a cloud framework with special emphasis on time (as low as s a minute) and space diversification and randomization across heterogeneous cloud platforms (i.e., OS, Hypervisors) while proactively monitoring the nodes, which includes VMI. We abstract the system runtime from the virtual machine (VM) instance to formally reason its correct behavior using a Dynamic Bayesian Network. This abstraction allows the framework to enable MTD capabilities to all types of systems regardless of its architecture or communication model (i.e., Asynchronous and Synchronous) on all kinds of cloud platforms (i.e., OpenStack and OpenNapula).

The Mayflies framework is diagrammatically illustrated in FIG. 4 and, in this embodiment, is built on top of a cloud framework 80, a widely adopted open source cloud management software stack that consists of many independent components such as nova compute 82, horizon 84, neutron 86. The Mayflies framework adopts a cross-vertical design that operates on three different logical layers of the cloud framework; the nova compute 82 at the application layer (GuestOS layer 64), the VMI at the hypervisor layer (HostOS layer 62), and the neutron 86 at the networking layer.

In the cloud framework shown in FIG. 4, the bottom layer is the hardware 60. Each hardware has a host OS 88, a hypervisor 90 (KVM/Xen) to virtualize the hardware for the guest VMs on top of it, and the cloud software stack framework 80, OpenStack in our case. The vertical bars are some of the OpenStack framework implementation components including nova (not shown), neutron 86, horizon 84, and glance 92. In addition, the Mayflies framework includes libvmi 94, a library for virtual machine introspection to peek at live memory activities at the hypervisor-level.

The Mayflies framework includes two abstraction layers; a high-level System State 96 (top) and the Application Runtime 98 (bottom), dubbed time-interval runtime 100. To illustrate, for the system state, we consider Desired 72 as the desired system state at all times, and Undesired 74 as the state we like to avoid (i.e., turbulence, compromised or failed system state). The driving engine of these two high-level states is the observations from the application runtime by the proactive monitoring enabled by the libvmi depicted as dotted arrows 70. The System State 96 and the Application Runtime 98 are two abstraction layers that operate in synchrony. At the application runtime layer, VMs depicted in GuestOS (VM1 . . . VMₙ) are proactively refreshed on different platforms as depicted on Hardware 60 (Hardware1 . . . HWₙ) 60 in pre-specified time intervals, referred to as time-interval runtime. To gain a holistic view of the high-level system state, we re-evaluate the system state at the end of each interval to determine whether the system is in a desired state 72 or undesired state 74.

The key objective of the Mayflies defense is to start the system in a Desired state 72 and stay in that state as often as possible. If the system transitions into Undesired state 74, a valid assumption in cyber space, the Mayflies defense should cause the system to bounce back seamlessly into the Desired state 72. As the cloud frameworks 80 (i.e., OpenStack) abstracts the compute nodes from the deployed systems regardless of their architectural style (i.e., SOA) or its communication model (i.e., synchronous vs. asynchronous) with a unified deployment models (i.e., IaaS, AaaS, SaaS), the Mayflies framework abstracts the system's application runtime 98 from the VMs that are deployed in order to break the runtime into observable time-intervals regardless of the application type. This allows Mayflies to model both the system state 96 and the runtime 98 independently, and therefore, the defense identifies the transitions between the Desired and the Undesired states (72 and 74) and acts in response to that transition.

Application Runtime

Mayflies transforms the traditional services designed to be protected their entire runtime (as shown on the guest VMs 102 on the cloud framework 80) to services that deal with attacks in time intervals. Such transformation is achieved by allowing the applications to run on heterogeneous OSs and variable underlying computing platforms (i.e., hardware and hypervisors), thereby, creating a mechanically generated system instance(s) that is diversified in time and space which is considered a defense as good as type-checking [52]. Formally. we define time-interval as follows: Time-Interval in Mayflies is defined as a time unit. We use Tᵢ to denote each time interval where i=1, 2, 3 . . . are unites of time, typically minutes or hours.

The goal is for each node in the system to operate only for a predefined lifespan, as low as a minute. This time unit can be a system time unit or upon completing certain number of n transactions/service responses which translates to the time it takes to complete n transactions (i.e., seconds/minutes). Upon reaching this lifespan, the node is terminated and instantiated on a different platform, we call it Node Reincarnation. This process reduces the exposure attack window time of the node and subverts in progress attacks while continuously re-assessing the system state based on the observations of the nodes that are not being reincarnated. Thus, it is intuitive to see that defending systems in T₀ for the run time on all replicas (traditional deployment) is extremely challenging in comparison with defending it in Tᵢ, where i>0, and Tⱼ (lifespan) is within minutes.

Therefore, it is critical to abstract the traditional application runtime model with Time-Interval Runtime Execution Model. This abstraction transforms the system run time into observable (with respect to security) system states. However, the key design challenge inherent in such run time execution model is dealing with the application state between the terminating and the new instance/node without disrupting the computation.

Generally, application state is an abstract notion of a continuous memory region of the application at runtime. Breaking this runtime into intervals (chunks) across nodes, will break the continuity of that region, however, the implementation of such abstraction is dictated by how the application constructs and preserves its state at runtime. Thus, the challenge of transferring application state between a terminating node and a new node lies in the communication model (i.e., synchronous vs. asynchronous) between the interconnected applications/services or between the client and the servers.

For example, the state information of Byzantine Fault-Tolerant Replicated systems (i.e., synchronous system model), manages a static and a dynamic part of the system state. The dynamic part is typically written in a file to assist the recovering replica, and thus, transferring that file implies state transfer. Another example of a asynchronous system is the event based systems where the state is the registered subscriptions and the events entering in the system. Terminating the node with the registration information requires transferring the information to the new node.

In most applications, the static part of the application state is called the system configuration files, which is typically saved in a file (system.config or hosts). The static information in these files typically contains the application parameters like the number of participating replicas and their IP addresses, the database connection strings, security keys/certificates, etc. These parameters are not updated at runtime unless the application implement protocols to handle this update, for instance, replicated systems that allow replicas to join or leave the systems.

Yet another widely adopted example is in the web services domain, for example, RESTful web services, a stateless web service (client/server) model where the client requests are processed and responded to as they enter the system, thereby, no state is preserved. In contrast, for stateful services, the services are bound by their communication protocols (like WS-Secure Conversation) and also their access control token during a session.

Managing the dynamic part of the application state in a generic fashion is not feasible, since it's application dependent. In Mayflies, we exploit the built-in reliability properties of the application where applications retry to connect to the service/replica for few times before it gives up. Our reincarnation process completes within these tries. Thus, Mayflies does not transfer the dynamic part of the application state (i.e., TCP connections, security tokens). These states are typically exchanged between the running replicas and the recovering one, where in our case, is the reincarnating node.

Mayflies Framework Components

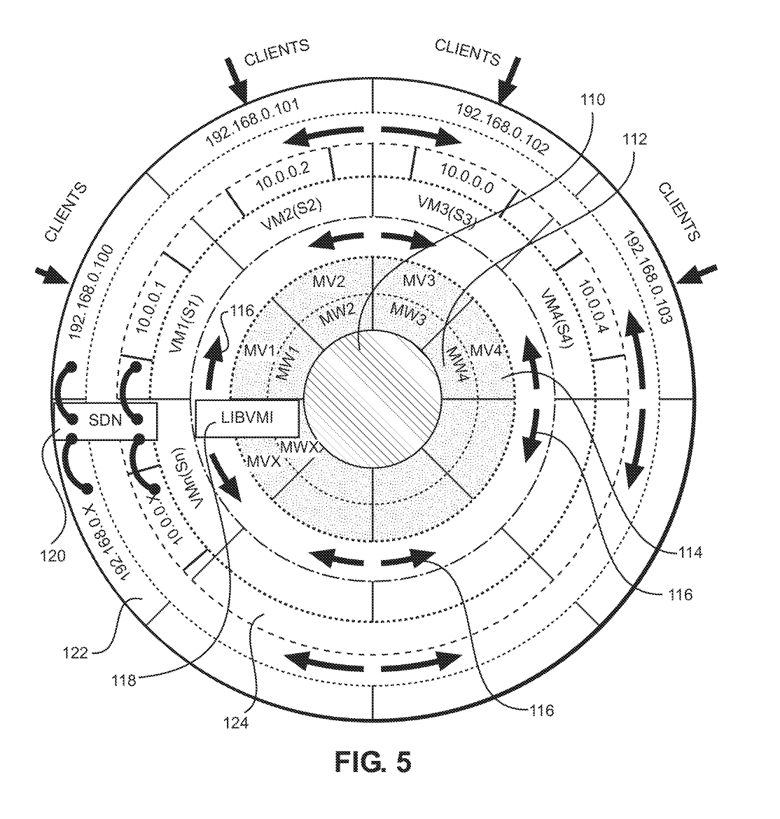

FIG. 5 shows a cross sectional view of the Mayflies cloud platform. At the core, is the OpenStack cloud management framework 110 where the nodes/VMs are provisioned and deprovisioned on the hardware 112 (HW1 . . . HWn) mediated by the hypervisors 114 (HV1 . . . HVn), depicted on the third rings. The arrows 116 represent the node randomization and diversification techniques of Mayflies across these hardwares. The LibVMI 118 and SDN 120, depicted on the rectangles, are for the proactive monitoring component and the network programming respective layers. Note that the clients' access is through the external IP addresses 122 (192.x.x.x) and the VMs are interconnected with the internal IP addresses 124 (10.x.x.x). Mayflies implements software utilizing the cloud framework (i.e., Openstack) components; nova compute, neutron, and Virtual Machine Introspection (VMI) for detecting runtime integrity violations in real-time. The nova compute is designed for provisioning/de-provisioning VM instances on the cloud platforms. Mayflies is continuously provisioning/de-provisioning nodes in time intervals at run time, dubbed Node Reincarnation, and it uses neutron to dynamically reconfigure the network during the reincarnations. Mayflies leverages libvmi 118, a library for virtual machine introspection (VMI) for pro-active node monitoring on application runtime.

Proactive Node Monitoring

Pro-actively monitoring the nodes during their short lifespan is critical. The key idea is to prioritize node reincarnations with respect to the overall system state to prevent reincarnating nodes on a compromised cluster or reincarnating a node due to its lifespan while another compromised node is in the system. Effective monitoring prevents blind moves of nodes across platforms. The easiest method to get the node status is by pinging the node, however, one Mayflies objective is to defend systems against advanced attacks, and depending on the existence of the node status does not say anything about attacks. We define node status as follows:

Node status in Mayflies defines the node to be clean if the observation from the internal representation of the node's runtime (i.e., memory, CPU) integrity is intact and to be dirty if the integrity is violated.

Mayflies is configured to monitor nodes at the infrastructure level. In cloud platforms, there are numerous ways of achieving this capability. The hypervisor is the core machinery that mediates between the virtual resources of the VM and the physical resources such as memory and CPU. The transparent mapping of the virtualized OS memory into the physical memory enabled by the hypervisor opens the opportunity to safeguard systems below the OS which is difficult to subvert by attacks originated inside the OS. Thus, Mayflies leverages VMI for proactive monitoring of the VMs. In VMI, for instance, when the application is hijacked, the address offsets show new entries for the injected code. Another instance is when the application is terminated and a new malicious one is started which possibly ends up with a new process ID and/or a different memory address offset in its virtual memory address space. Note that VMI is a powerful memory inspection tool used for malware analysis and other intrusion detection methods. Since Mayflies is monitoring at runtime, it uses VMI in its simplest fashion which has a negligible performance overhead. The Virtual Introspect code below illustrates the introspection procedure, INTROSPECT( ).

Algorithm 1 Virtual Introspect

| | |
|---|---|
| 1: | Input: node |
| 2: | Output: true or false |
| 3: | procedure INTROSPECT(node) |
| 4: | if node == new then |
| 5: | initial Proc ← Get Process Memory (node) |
| 6: | return false |
| 7: | else |
| 8: | current Proc ← Get Process Memory (node) |
| 9: | if initial Procᵢ (key,val) ≠ current Procᵢ (key,val) then |
| 10: | return true |
| 11: | else |
| 12: | return false |
| 13: | end if |
| 14: | end if |
| 15: | end procedure |

INTROSPECT( ) saves the initial memory information of the node in line 5 and returns false for a clean new node. Then, returns true, accordingly, when the running node's information is different/altered from the initial stored information in lines 8 and 9. The result can be either true if anomaly is detected in the memory structure, otherwise false. Note that we can check any key/value pairs in the memory data structure such as the start/end address offsets of a given process.

Formally, let {Oⱼ, j=1, 2, . . . } be observations of the node status n∈N, where N is the set of nodes. We model these observation as a Bernoulli processes where Oj ∈{0,1} in which Oj=1 indicates an observed node is clean and Oj=0 indicates the node is dirty. The dirty node can be either missing (i.e., network drop) or it's compromised (i.e., VMs address space altered).

In order to break the application's runtime into manageable time-intervals, Mayflies separates the network interface known to the users from the VM in order to attach it to the substituting node without the user's knowledge. This node can be from a pool of prepared nodes or a newly created VM. VMs are typically interconnected with fixed IP addresses, similar to a LAN setting in a corporate network, and are reached by the clients through floating IP addresses through a virtual router. The prepared nodes can be created on the network with fixed IPs (i.e., LAN IP assigned by DHCP but not externally feasible) or off the network (i.e., no network card). The procedure simply creates a new interface if the node is originally created without an interface (a standby VM), or otherwise, attaches from the interface from the old node. This is achieved with the Software Defined Networking (SDN). SDN is a programmable networking fabric that decouples the control plane from the data plane (i.e., switches). The OpenStack neutron component implements the SDN interfaces and others are enabled indirectly through the nova component.

Node Reincarnation

Reincarnation is a technique of enhancing the resiliency of a system by terminating a running node and starting a fresh new one in its place on (possibly) a different platform/OS as it dropped off of the network and reconnected to it. The node reincarnation procedure is illustrated in Algorithm 3. In REINCARNATE( ) procedure, we first save the nodes application state then destroy the VM (deleting the VM) in lines 2 and 3. We get a new node from the pool in line 4, then, swap its network interface in line 5, and transfer its state in line 6. The GetNewNode( ) method can be implemented in two different ways; by selecting a new VM from a pool of VMs or freshly booting a new VM on demand.

Algorithm 3 Node Reincarnation Procedure

```
Input: targetNode
Output: Substitute targetNode with a newNode
  1 procedure REINCARNATE( )
      2 nodeState ← targetNodestate
      3 DestroyTarget( )
      4 newNode ← GetNewNode( )
      5 InterfaceSwap(nodeState, newNode)
      6 newNode state ← nodeState
    7 end procedure
```

Different Strategies of Reincarnation

Reincarnation may be accomplished differently according to the needs of a particular network. Two examples of reincarnation strategies are round-robin and random. In Algorithm 4 (shown below), lines 3 through 13 show the round-robin strategy. We continuously reincarnate nodes in round robin fashion, going through the list of nodes over and over again. This can be implemented, for example, by a circular linked-list. The second strategy is reincarnating a node by simply selecting it randomly shown in lines 14 through 27. Assuming the node IDs are numbered 1 . . . n, we simply generate a random number within the range of the node IDs and reincarnate accordingly.

Algorithm 4 Mayflies Algorithm

| 1: | Initialize the replicas and time-interval x/lifespan | |
|---|---|---|
| 2: | while true do | |
| 3: | if strategy = Round Robin then | |
| 4: | repeat | |
| 5: | is Dirty ← INTROSPECT i(replicaᵢ) | [symbol] any dirty node? |
| 6: | if is Dirty then | [symbol] in algorithm 1 |

| 7: | REINCARNATE (replicaᵢ) | [symbol] terminate the dirty node first |
|---|---|---|
| 8: | else | |
| 9: | target Node ← GET NODE ( ) | [symbol] scheduled node in ordered list |

| | | |
|---|---|---|
| 10: | REINCARNATE (target Node) | [symbol] in algorithm 3 |

| 11: | end if | |
|---|---|---|
| 12: | WAIT (x) | [symbol] sleep for x minutes/transactions |

| 13: | until stop MTD condition met | |
|---|---|---|
| 14: | else if strategy = Random then | |
| 15: | repeat | |
| 16: | is Dirty ← INTROSPECT (replicaᵢ) | [symbol] any dirty node? |
| 17: | if isClean then | [symbol] in algorithm 1 |

| | | |
|---|---|---|
| 18: | REINCARNATE (replicaᵢ) | [symbol] terminate the dirty node first |

| 19: | else | |
|---|---|---|
| 20: | repeat [symbol] get a different node than the other one just reincarnated | |
| 21: | id ← RANDOM GEN ( ) [symbol] get a random number within ID range | |
| 22: | until id ≠replicaᵢ I D | |
| 23: | target Node ← GET NODE (id) | |
| 24: | REINCARNATE (target Node) | [symbol] in algorithm 3 |

| 25: | end if | |
|---|---|---|
| 26: | WAIT (x) | [symbol] sleep for x minutes/transactions |

| | |
|---|---|
| 27: | until stop MTD condition met |
| 28. | end if |
| 29: | end while |

Note that INTROSPECT(replicai) in lines 5 and 16, described in Algorithm 1 is an implementation dependent. For instance, we need to introspect the replica index i from the list in descending order and reincarnate in ascending order for the round-robin strategy. For the random strategy, we don't need to reincarnate the node that was just introspected.

We implemented our algorithms with bash shell scripts tightly integrated into the OpenStack (Kilo) framework. OpenStack provides modularized components (i.e., computing virtualizaiton and SDN) that simplify cloud management and ease of integration. With this, by orchestrating the interfaces implemented in these components, we extended the cloud framework with our Mayflies MTD framework. In Algorithm 4, there are five procedure calls: GETNODE( ), INTROSPECT( ) (previously discussed), REINCARNATE( ) (previously discussed), RANDOM( ) and WAIT( ). The implementation is as follows:

GetNode( ), Wait( ) and Random( )

Depending on the data structure used to keep track of the nodes, the GETNODE( ) procedure is simply extracting a target node from the list, for instance, by index if it is a list or an array. The target node is selected randomly in the RANDOM( ) procedure using a basic random generator function. Similarly, The WAIT( ) procedure is simply a sleep (x) method call for x amount of time, else lifespan is used where the node self-terminates after x number of transactions/execution completes. By adjusting the time of the WAIT( ) procedure, the life expectancy of each node can be calculated. In the case of GETNODE( ) procedure, the life expectancy will normally be very consistent, but even using the GETNODE( ) procedure, the actual lifespan of a node can be extended because the attacked nodes are destroyed first. In the case of the RANDOM( ) procedure, the lifespan of each node will vary depending on the number of attacks detected and also depending on the random order of selection for destruction. Thus, a lifespan procedure is run simultaneously with the other procedures and the lifespan procedure will cause the destruction of any node at the end of its lifespan automatically if it has not been previously destroyed.

Introspect( )

We leveraged LibVMI [37], an open source library for Virtual Machine Introspection. Algorithm 1 illustrates the detection scheme, and in summary, we first take a snapshot of the application's memory before we deploy/assign an IP address. We next take snapshots in time intervals and compare specific elements in the address block like the address offsets and alert if entries mismatch.

Reincarnate( )

The reincarnation procedure is to reincarnate a target node if it is found dirty (i.e., compromised) by the introspection procedure, otherwise reincarnate as scheduled, illustrated in lines 7 and 10 for the round-robin strategy, and lines 18 and 24 for the random strategy in Algorithm 4 Assuming that the adversary can learn the tactics used for reincarnating nodes, for instance, when using round-robin strategy, the attacker can focus attacking those nodes that have longer exposure attack window or are last in the list/array. To balance, the introspection monitoring scheme should be constantly monitoring those nodes rather than those that are soon to be reincarnated.

There are different ways to implement node reincarnation in OpenStack. The nova boot <options> lets you create nodes, where the options specify the type of the node; cluster, OS type, etc. Depending on the time-criticality of the application, a node is booted on-demand or selected from prepared pool of VMs without network interface attached or prepared with temporary interfaces.

The Reincarnate( ) procedure uses an InterfaceSwap( ) procedure as illustrated in Algorithm 3. This procedure is implemented as follows: we first save the port ID associated to the terminating replica (the input replica). In SDN environment, the VM is attached to a virtual network interface that is referred to as ports with a fixed IP similar to physical network interfaces. This interface is also associated with floating IP for external access as noted earlier in FIG. 3.3. Thus, both of the IP addresses are part of the port even after it's separated from the VM, thereby, transferable to another VM. We detach the port off of the replica with nova interface-detach <newReplica portID>, we then get a new replica VM instance from the pool and attach the port to it. Note that depending on the OS image of the replica, a VM reboot is required after the nova interface-attach <portID newReplica>. At this point, the clients re-connect to this replica through its floating IP (128.x.x.x) as the old server that dropped off of the network and came back.

The pseudo-code below reflects the implementation logic in code snippets:

Algorithm 5 Reincarnate

| | |
|---|---|
| 1: | if nodeHasNetworkPort then |
| 2: | nova interface−dis−associate <VM_{old}, FloatingIP> [symbol] remove IP |
| 3: | nova interface−associate <FloatingIP, VM_{new}> [symbol] give IP |
| 4: | else |
| 5: | neutron port−create <options> [symbol] create virtual network card |
| 6: | neutron port−attach <options> [symbol] attach card |
| 7: | end if |
| 8: | if nodeHasNetworkInterface then |
| 9: | $nova interface - detach < {VM}_{old ,} {VM}_{{old}_{{port}_{ID}}} > ⊳ remove network interface$ |
| 10: | else |
| 11: | $nova interface - attach < {VM}_{new} {VM}_{{old}_{{port}_{ID}}} > ⊳ give network interface$ |
| 12: | end if |

For the node without the interface, we use neutron port-create <options> to re-create the interface with attributes used by a terminating VM and then pass to another VM with neutron port-attach <options>, thereby allowing the servers (if replicated) to continue using the known interface. With these capabilities, we can reincarnate nodes across subsets and networks.

From the above description, it is seen that an effective defense strategy is implemented by a combination of strategies that routinely destroys all VMs (or all VMs in a group to be protected) based on varying criteria and reincarnates the VMs. Both VM destruction and VM reincarnation provide a defense to attacks. The attacked VMs are destroyed first, and the remaining VMs may be destroyed on a schedule that may be sequential or otherwise predictable, or the remaining VMs may be destroyed based on pseudo-random selection. Attacks are monitored at a level other than the operating system of the VM, and for example an attack may be determined by monitoring a VM at the hypervisor level of cloud software. A Lifespan procedure may be superimposed on the destruction schedule that limits the lifespan of each VM to a predetermined lifespan. The predetermined lifespan may be a time ranging between a maximum and a minimum, and the exact time of the lifespan selected for each VM may be randomly determined or predictably determined. For example, each predetermined lifespan could be exactly the same. Even if all lifespans set to the same time period, the actual life of a VM may be shorter because a VM may be destroyed earlier by one of the other procedures described above. However, the time of each lifespan could be determined pseudo-randomly and the VMs could be subjected to the RANDOM( ) procedure of destruction described above and thus two random limits are simultaneously imposed on the life of each VM. The reincarnation process also provides a level of security by providing different methods of providing a reincarnated new VM, by subjecting VMs to destruction even before the VM is placed into use running a user application, and by reincarnating a VM is a different form that is more resistive to attack.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A computer apparatus comprising:
at least one computer;
at least one operating system running on the computer;
cloud software running on the computer and supporting a plurality virtual machines;
user applications interfaced with at least some of the virtual machines;
defense software implemented on the cloud software for providing a moving target defense, the defense software being operable to:
destroy any of the plurality of virtual machines on a schedule of destruction;
create virtual machines in the cloud software wherein when each particular virtual machine is scheduled for destruction, reincarnating the particular virtual machine by providing a replacement virtual machine and migrating user applications from the particular virtual machine to the replacement virtual machine.

2. The apparatus of claim 1 wherein the defense software is further operable:
to run a first destruction procedure wherein at least one group within the plurality of virtual machines is selected for destruction and the virtual machines in the group are destroyed in a random sequence with wait times between the destruction of the virtual machines;
to run a second destruction procedure wherein each virtual machine in the group is assigned a lifetime and each virtual machine in the group is destroyed at the end of the lifetime assigned to each virtual machine, if not earlier destroyed by the first destruction procedure.

3. The apparatus of claim 1 wherein the defense software is further operable:
to run a first destruction procedure wherein at least one group within the plurality of virtual machines is selected for destruction on a round-robin schedule and the virtual machines in the group are destroyed in a sequence based on the age of the virtual machines with the oldest virtual machines being scheduled for the earliest destruction under the round-robin schedule; and
to run a second destruction procedure wherein each virtual machine in the group is assigned a lifetime and each virtual machine in the group is destroyed at the end of the lifetime assigned to each virtual machine, if not earlier destroyed by the first destruction procedure.

4. The computer apparatus of claim 1 wherein the defense software is configured to monitor at least one group of virtual machines for an attack, and if an attack on a virtual machine is detected, the defense software is configured to destroy the virtual machine in advance of its scheduled destruction under the schedule of destruction.

5. The computer apparatus of claim 1 wherein:
the defense software is configured to monitor at least some virtual machines for an attack, and if an attack on a virtual machine is detected, the defense software is configured to destroy the virtual machine in advance of its scheduled destruction under the schedule of destruction; and
if a user application is running on the attacked virtual machine, the defense software is further configured to migrate the user application from the attacked virtual machine to a new virtual machine that has characteristics that are different from the attacked virtual machine so that the new machine is less susceptible to the attack.

6. The computer apparatus of claim 1 wherein:
the defense software is configured to monitor at least some virtual machines for an attack, and if an attack on a virtual machine is detected, the defense software is configured to destroy the virtual machine in advance of its scheduled destruction under the schedule of destruction; and
if a user application is running on the attacked virtual machine, the defense software is further configured to migrate the user application from the attacked virtual machine to a new virtual machine that is located on a different hardware platform and has a different operating system as compared to the attacked virtual machine.

7. The computer apparatus of claim 1 wherein the defense software is configured to monitor at least a group of virtual machines for an attack using the cloud software and a Virtual Machine Introspection technique of monitoring for an attack, and if an attack on a virtual machine is detected, the defense software is configured to destroy the virtual machine in advance of its scheduled destruction under the schedule of destruction.

8. The computer apparatus of claim 1 wherein the defense software is configured to destroy the virtual machines on a schedule of destruction that causes at least some of the virtual machines to have different lifespans.

9. The computer apparatus of claim 1 wherein the defense software is configured to provide multiple techniques of timing the creation of new virtual machines relative to the timing of the destruction of existing virtual machines.

10. The computer apparatus of claim 1 wherein the defense software is configured to create a new virtual machine at a predetermined time interval before an existing virtual machine is destroyed.

11. The computer apparatus of claim 1 wherein the defense software is configured to create a new virtual machine at a first time without an interface and then to create an interface for the new virtual machine at a second time, whereby the new virtual machine is protected from attack by the absence of an interface for a period of time.

12. The computer apparatus of claim 1 wherein the defense software is configured to migrate a user application from a first virtual machine to a second virtual machine by:
copying a state of the user application running on a first virtual machine;
starting a duplicate of the user application on the second virtual machine;
transferring the state to the duplicate application running on the second virtual machine.

13. The computer apparatus of claim 1 further comprising:
multiple duplicate copies of a user application running on multiple virtual machines of the apparatus, wherein the duplicate copies of the application each have a state and the states are periodically synchronized,
the defense software being configured:
to detect the presence of the multiple duplicate copies of a user application that are synchronizing and are running on the multiple virtual machines;
to periodically destroy one of the multiple virtual machines and thereby also destroy one copy of the user application;
to create a new copy of the user application on a new virtual machine without transferring the state of the one copy of the application that was destroyed; and
to synchronize the state of the new copy of the user application with the remaining duplicate copies of the user application, whereby the new copy of the user application replaces the one copy of the user application that was destroyed.

14. The computer apparatus of claim 1 wherein the schedule of destruction is configured to limit the life of each virtual machine to a period of time that is sufficiently short such that a successful attack on the virtual machine is unlikely.

15. The computer apparatus of claim 1 wherein the schedule of destruction is configured to provide each virtual machine with a life that is sufficiently long to efficiently operate a predetermined user application.

16. A method for defending a computer apparatus having at least one computer; at least one operating system running on the computer; cloud software running on the computer and supporting a plurality virtual machines; and user applications interfaced with at least some of the virtual machines; the method comprising:
destroying the plurality of virtual machines on a schedule of destruction;
reincarnating each virtual machine that is destroyed by:
providing a substitute virtual machine for each destroyed virtual machine; and
if needed, transferring a state of each virtual machine that is destroyed to the substitute virtual machine;
when each particular virtual machine is scheduled for destruction, migrating user applications from the particular virtual machine to the replacement virtual machine immediately prior to destroying the particular virtual machine.

17. The method of claim 16 further comprising:
running a first destruction procedure wherein at least one group of virtual machines within the plurality of virtual machines is selected for destruction and the virtual machines in the group are destroyed in a random sequence with wait times between the destruction of the virtual machines;
running a second destruction procedure wherein each virtual machine in the group is assigned a lifetime and each virtual machine in the group is destroyed at the end of the lifetime assigned to the virtual machine, if not earlier destroyed by the first destruction procedure.

18. The method of claim 16 further comprising:
running a first destruction procedure wherein at least one group of virtual machines within the plurality of virtual machines is selected for destruction on a round-robin schedule and the virtual machines in the group are destroyed in a sequence based on the age of the virtual machines with the oldest virtual machines being scheduled for the earliest destruction under the round-robin schedule; and
running a second destruction procedure wherein each virtual machine in the group is assigned a lifetime and each virtual machine in the group is destroyed at the end of the lifetime assigned to each virtual machine, if not earlier destroyed by the first destruction procedure.

19. The method of claim 16 further comprising:
monitoring at least some virtual machines for an attack, and if an attack on a virtual machine is detected, destroying the virtual machine that is under attack in advance of its scheduled destruction under the schedule of destruction; and
if a user application is running on the attacked virtual machine, migrating the user application from the attacked virtual machine to a new virtual machine that is located on a different hardware platform and has a different operating system as compared to the attacked virtual machine.

20. A method for defending a computer apparatus having at least one computer; at least one operating system running on the computer; cloud software running on the computer and supporting a plurality virtual machines; and user applications interfaced with at least some of the virtual machines; the method comprising:
destroying the plurality of virtual machines on a schedule of destruction, including:
running a first destruction procedure wherein at least one group of virtual machines is selected for destruction and the virtual machines in the group are destroyed in either a random sequence or a round-robin sequence with wait times between the destruction of the virtual machines, the round-robin sequence scheduling the destruction of virtual machines in order of the age of the virtual machines with the older virtual machines being destroyed earlier;
running a second destruction procedure wherein each virtual machine in the group is assigned a lifetime and each virtual machine in the group is destroyed at the end of the lifetime assigned to each virtual machine, if not earlier destroyed by the first destruction procedure;
reincarnating each virtual machine that is destroyed by:
providing a substitute virtual machine for each destroyed virtual machine; and
if needed, transferring the state of each virtual machine that is destroyed to the substitute virtual machine;
when each particular virtual machine is scheduled for destruction, migrating user applications from the particular virtual machine to the replacement virtual machine immediately prior to destroying the particular virtual machine;
monitoring at least some virtual machines for an attack, wherein the activity of each virtual machine is monitored at a hypervisor level of the cloud software using Virtual Machine Introspection, and if an attack on a virtual machine is detected, destroying the virtual machine that is under attack in advance of its scheduled destruction under the schedule of destruction; and
if a user application is running on the attacked virtual machine, reincarnating the attacked virtual machine by migrating the user application from the attacked virtual machine to a new virtual machine that is located on a different hardware platform and has a different operating system as compared to the attacked virtual machine.
